(19) United States
(12) Patent Application Publication
(10) Pub. No.: US 2026/0045851 A1
(43) Pub. Date: Feb. 12, 2026

(54) SPEED REDUCTION ROTATION DEVICE BASED ON PHOTOVOLTAIC MODULES

(71) Applicant: 3X MOTION TECHNOLOGIES CO., LTD., CHANGZHOU (CN)

(72) Inventors: JINKUAN NI, CHANGZHOU (CN); NIGEN YANG, CHANGZHOU (CN); XIANGJUN GE, CHANGZHOU (CN); YI SHENG, CHANGZHOU (CN); CHENXIAO ZHANG, CHANGZHOU (CN)

(73) Assignee: 3X MOTION TECHNOLOGIES CO., LTD., CHANGZOU (CN)

(21) Appl. No.: 19/003,097

(22) Filed: Dec. 27, 2024

(30) Foreign Application Priority Data
Aug. 6, 2024 (CN) 2024110675990

(51) Int. Cl. H02K 7/116; H02K 9/06; H02K 21/16; H02S 20/32

(52) U.S. Cl. CPC H02K 7/116; H02K 9/06; H02K 21/16; H02S 20/32

(57) ABSTRACT

The present application relates to a speed reduction rotation device based on photovoltaic modules, which includes a high tooth-slot torque permanent magnet motor and a planetary reducer. The output of the motor is connected to the input of the planetary reducer. The motor includes a stator body with multiple stator slots and a rotor body with permanent magnets, where the ratio of stator slots to magnets is a multiple of 3:2. This application utilizes the high tooth-slot torque of the permanent magnet motor, which, when amplified by the speed ratio of the planetary reducer, achieves sufficient reverse braking torque to resist reverse torque on the actuator shaft caused by external forces. Additionally, replacing the worm gear reducer with the planetary reducer for speed reduction and rotation of the actuator shaft improves service life, energy efficiency, and reliability while reducing product costs.

### TECHNICAL FIELD

The present application relates to the technical field of speed reduction and rotation mechanisms, particularly to a speed reduction rotation device based on photovoltaic modules.

### BACKGROUND

Photovoltaic modules, also known as solar cell modules, are composed of solar panels and aluminum alloy frames. They are characterized by a long service life and strong mechanical resistance to compressive forces.

Currently, to enhance the efficiency of photovoltaic modules, they are typically equipped with speed reduction rotation mechanisms, enabling the photovoltaic modules to rotate and follow the sun. Existing speed reduction rotation mechanisms for photovoltaic modules include a series of interconnected components: a brushless DC motor, a planetary reducer, and a worm gear reducer. The backside of the photovoltaic module is equipped with an actuator shaft, which is rotatably mounted on a photovoltaic support. The output end of the worm gear reducer is connected to the actuator shaft.

Regarding the aforementioned technical solutions, the inventors recognize that although worm gear reducers possess a self-locking feature that ensures the stability of photovoltaic module operation, the use of a worm and worm wheel transmission structure within the worm gear reducer results in a large meshing angle between the worm and the worm wheel. This leads to significant frictional and thermal losses, thereby causing high energy consumption, increased costs, reduced efficiency, and shortened lifespan.

### SUMMARY

To enhance service life, energy efficiency, and reliability while reducing product costs, the present application provides a speed reduction rotation device based on photovoltaic modules.

The speed reduction rotation device based on photovoltaic modules provided by the present application adopts the following technical solution:

A speed reduction rotation device based on photovoltaic modules, comprising a high tooth-slot torque permanent magnet motor and a planetary reducer. The output end of the high tooth-slot torque permanent magnet motor is connected to the input end of the planetary reducer. The high tooth-slot torque permanent magnet motor includes a stator body and a rotor body. The stator body is provided with M stator slots, and the rotor body is provided with N permanent magnets, wherein the ratio of M to N is a multiple of 3:2.

By adopting the above technical solution, during use, the output end of the planetary reducer is connected to the actuator shaft of the photovoltaic module. After the high tooth-slot torque permanent magnet motor outputs torque, the planetary reducer with a large speed ratio amplifies the torque according to the speed ratio and supplies it to the actuator shaft, thereby achieving the purpose of driving the photovoltaic module to rotate. Compared to the self-locking feature of a worm gear reducer, the slot-to-pole ratio of the high tooth-slot torque permanent magnet motor in the present application is a multiple of 3:2. By utilizing the high tooth-slot torque of the high tooth-slot torque permanent magnet motor and amplifying it through the speed ratio of the planetary reducer, sufficient reverse braking torque is achieved, capable of resisting reverse torque on the actuator shaft caused by external forces such as strong winds or foreign objects. Additionally, using a planetary reducer instead of a worm gear reducer to achieve speed reduction and rotation of the actuator shaft is beneficial for improving service life, energy efficiency, and reliability, while reducing product costs.

In a preferred embodiment, the pole arc coefficient of the high tooth-slot torque permanent magnet motor is greater than 0.75.

By adopting the above technical solution, it is ensured that the high tooth-slot torque permanent magnet motor has high efficiency and power density, thereby reducing energy consumption, improving energy efficiency, and achieving motor lightweighting.

In a preferred embodiment, the permanent magnets are affixed to the outer peripheral surface of the rotor body.

By adopting the above technical solution, the permanent magnets have a surface-mounted structure, enabling the high tooth-slot torque permanent magnet motor to have higher power density and magnetic field utilization, ensuring high efficiency and high control precision.

In a preferred embodiment, the rotor body is disposed on the inner side of the stator body.

By adopting the above technical solution, the high tooth-slot torque permanent magnet motor has an internal rotor structure, resulting in a small rotor inertia, fast response speed, and high protection level.

In a preferred embodiment, the speed ratio of the planetary reducer is greater than 10,000:1.

By adopting the above technical solution, it is ensured that the planetary reducer has a large speed ratio, making the speed reduction rotation mechanism suitable for low-speed and high-torque transmission application scenarios.

In a preferred embodiment, the high tooth-slot torque permanent magnet motor is provided with a mounting base at its bottom, and the mounting base is provided with at least two waist-shaped mounting holes.

By adopting the above technical solution, the provision of waist-shaped mounting holes facilitates the adjustment of the installation position of the high tooth-slot torque permanent magnet motor, thereby simplifying the installation process of the high tooth-slot torque permanent magnet motor.

In a preferred embodiment, the high tooth-slot torque permanent magnet motor is a high tooth-slot torque permanent magnet brushless DC motor.

By adopting the above technical solution, the high tooth-slot torque brushless DC motor exhibits stable torque, low starting current, high efficiency, and fast response characteristics, making it suitable for the rotational adjustment of photovoltaic modules.

In a preferred embodiment, the planetary reducer is internally provided with a cooling assembly. The cooling assembly includes a drive motor, which is fixedly connected to the inner wall of the top surface of the planetary reducer, and the power output shaft of the drive motor is connected via a coupling to a first gear. The surface of the first gear engages with a synchronous belt, and the inner wall of the end of the synchronous belt away from the first gear engages with a second gear. The top surface of the second gear is fixedly connected to a first shaft rod, which is rotatably arranged within a first shaft seat fixedly connected to the central inner wall of the top surface of the planetary reducer. The bottom surface of the second gear is fixedly connected to a fixed rod, whose surface is fixedly connected to a rotating bracket. The rotating bracket is rotatably arranged above the end of the fixed rod away from it and is fixedly connected to a third gear at its top surface. The bottom surface of the third gear is fixedly connected to a second shaft rod, which is rotatably arranged within a second shaft seat fixedly connected to the top surface of the rotating bracket. The inner wall of the planetary reducer is fixedly connected to an annular rack, which engages with the third gear. The top surface of the third gear is fixedly connected to a rotating disk. One end of the top surface of the rotating disk is fixedly connected to a first eccentric rod, whose surface is rotatably provided with a rotating plate. The interior of the rotating bracket is provided with a moving channel, within which a first fan bracket is slidably arranged. The inner wall of the first fan bracket is fixedly equipped with a first fan, and the central top surface of the first fan bracket is fixedly connected to a rotating rod. The rotating plate is rotatably arranged on the surface of the rotating rod away from the third gear. The bottom surface of the fixed rod is fixedly connected to a fixed disk, whose bottom surface is fixedly connected to a transmission rod. The outer wall of the transmission rod is fixedly connected to a second fan bracket, whose inner wall is fixedly equipped with a second fan. The bottom surface of the transmission rod is fixedly connected to a fan blade.

By adopting the above technical solution, the first fan rotates along the interior of the planetary reducer, achieving uniform cooling at different positions within the planetary reducer. Simultaneously, the first fan moves horizontally to cool different positions within the planetary reducer, thereby ensuring uniform cooling and achieving a good cooling effect, avoiding localized overheating, and ensuring the quality and lifespan of the planetary reducer. When the fixed rod rotates, the fan blade rotates accordingly, in conjunction with the first fan, directing heat away and accelerating the cooling process.

In a preferred embodiment, a planetary reducer is internally provided with a cooling assembly. The cooling assembly includes a fixed bracket, which is fixedly connected to the inner wall of the planetary reducer. One end of the fixed bracket away from the planetary reducer is fixedly connected to a cooling water tank. The cooling water tank is centrally hollow. The second fan bracket and the second fan are arranged within the central hollow portion of the cooling water tank. The fan blade is rotatably arranged below the cooling water tank. The outer wall of the cooling water tank is fixedly connected to a circulation pump. The input end of the circulation pump is fixedly connected to the outlet of the cooling water tank via a pipe, and the output end of the circulation pump is fixedly connected to a cooling coil. The cooling coil is fixedly connected to a return pipe at the end away from the circulation pump, and the return pipe is fixedly connected to the return inlet of the cooling water tank at the end away from the cooling coil. The cooling coil is arranged between the first fan and the fan blade. The outer wall of the fixed disk is fixedly connected to a rotating cover. The rotating cover is rotatably arranged on the top surface of the cooling water tank, and the outer end of the bottom surface of the rotating cover is fixedly connected to multiple second eccentric rods arranged in a circular array. The second eccentric rod is rotatably arranged inside the cooling water tank. The outer wall of the second eccentric rod is fixedly connected to a first turbulence plate, and the inner wall of the first turbulence plate is fixedly connected to a second turbulence plate. Multiple turbulence grooves are arranged within the first turbulence plate and the second turbulence plate.

By adopting the above technical solution, the airflow generated by the first fan acts on the cooling coil. The airflow is cooled through the cooling coil, reducing its temperature. The cooled airflow then acts on the interior of the planetary reducer, enhancing the cooling effect. A first turbulence plate and a second turbulence plate move within the cooling water tank, creating turbulence in the cooling liquid. In conjunction with turbulence grooves, the flow of the cooling liquid is improved and the cooling speed is accelerated. A second fan blows air towards the inner wall of the cooling water tank, further reducing the temperature of the cooling water tank and improving the cooling effect, thereby ensuring the quality and lifespan of the planetary reducer.

In Summary, the present application includes at least one of the following beneficial technical effects:
1. Compared to the self-locking feature of a worm gear reducer, the present application utilizes the high tooth-slot torque of the high tooth-slot torque permanent magnet motor. After amplifying the torque through the speed ratio of the planetary reducer, it achieves sufficient reverse braking torque, capable of resisting reverse torque on the actuator shaft caused by external forces such as strong winds or foreign objects. Additionally, using the planetary reducer instead of the worm gear reducer to achieve speed reduction and rotation of the actuator shaft is beneficial for improving service life, energy efficiency, and reliability, while reducing product costs.
2. In the present application, the pole arc coefficient of the high tooth-slot torque permanent magnet motor is greater than 0.75, ensuring that the high tooth-slot torque permanent magnet motor has high efficiency and power density. This, in turn, helps reduce energy consumption, improve energy efficiency, and achieve motor lightweighting.
3. In the present application, the high tooth-slot torque permanent magnet motor is a high tooth-slot torque brushless DC motor. The high tooth-slot torque brushless DC motor features stable torque, low starting current, high efficiency, and fast response, making it suitable for the rotational adjustment of photovoltaic modules.
4. In the present application, during the driving process of the planetary reducer, the first fan and the fan blade perform wind cooling, distributing wind force uniformly within the planetary reducer. Simultaneously, the generated airflow acts on the cooling coil, reducing the airflow temperature and enhancing the cooling effect.

### BRIEF DESCRIPTION OF THE DRAWINGS

FIG. 1 is a schematic diagram of the overall structure of a speed reduction rotation device based on photovoltaic modules according to an embodiment of the present application.

FIG. 2 is a schematic diagram showing the internal structure of a high tooth-slot torque permanent magnet motor according to an embodiment of the present application, wherein M:N=12:8.

FIG. 3 is a schematic diagram showing the internal structure of a high tooth-slot torque permanent magnet motor according to an embodiment of the present application, wherein M:N=24:16.

FIG. 4 is a cross-sectional side view of the planetary reducer of a speed reduction rotation device based on photovoltaic modules according to an embodiment of the present application.

FIG. 5 is a schematic diagram showing the connection structure between the cooling assembly and the cooling component of a speed reduction rotation device based on photovoltaic modules according to an embodiment of the present application.

FIG. 6 is a cross-sectional side view of the rotating bracket of a speed reduction rotation device based on photovoltaic modules according to an embodiment of the present application.

FIG. 7 is a cross-sectional side view of the cooling coil of a speed reduction rotation device based on photovoltaic modules according to an embodiment of the present application.

FIG. 8 is a cross-sectional side view of the cooling water tank of a speed reduction rotation device based on photovoltaic modules according to an embodiment of the present application.

Reference numerals list: 1, high tooth-slot torque permanent magnet motor; 11, stator body; 111, stator slot; 12, rotor body; 121, permanent magnet; 2, planetary reducer; 3, mounting base; 31, waist-shaped mounting hole; 4, cooling assembly; 401, drive motor; 402, first gear; 403, synchronous belt; 404, second gear; 405, fixed rod; 406, rotating bracket; 407, third gear; 408, annular rack; 409, rotating disk; 410, first eccentric rod; 411, rotating plate; 412, rotating rod; 413, first fan bracket; 414, first fan; 415, fixed disk; 416, transmission rod; 417, second fan bracket; 418, second fan; 419, fan blade; 5, cooling component; 501, fixed bracket; 502, cooling water tank; 503, circulation pump; 504, cooling coil; 505, return pipe; 506, rotating cover; 507, second eccentric rod; 508, first turbulence plate; 509, second turbulence plate; 510, turbulence groove.

### DETAILED DESCRIPTION

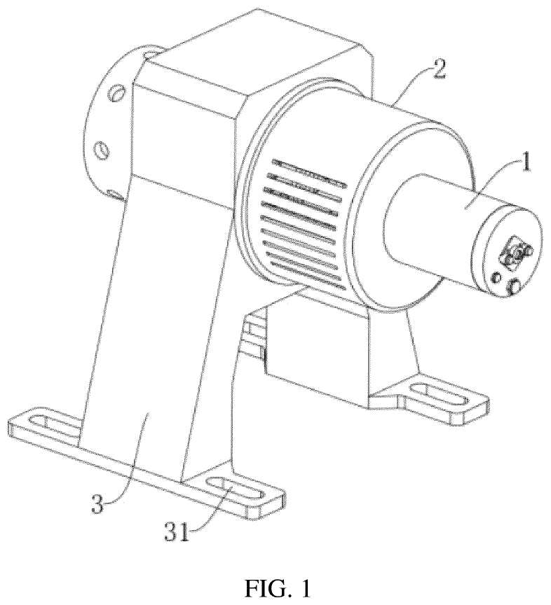

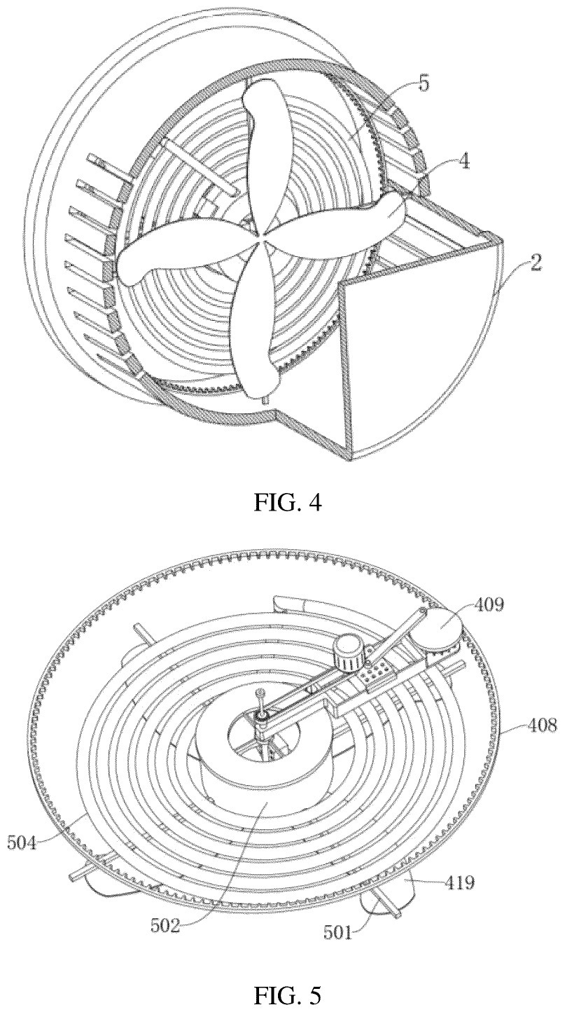

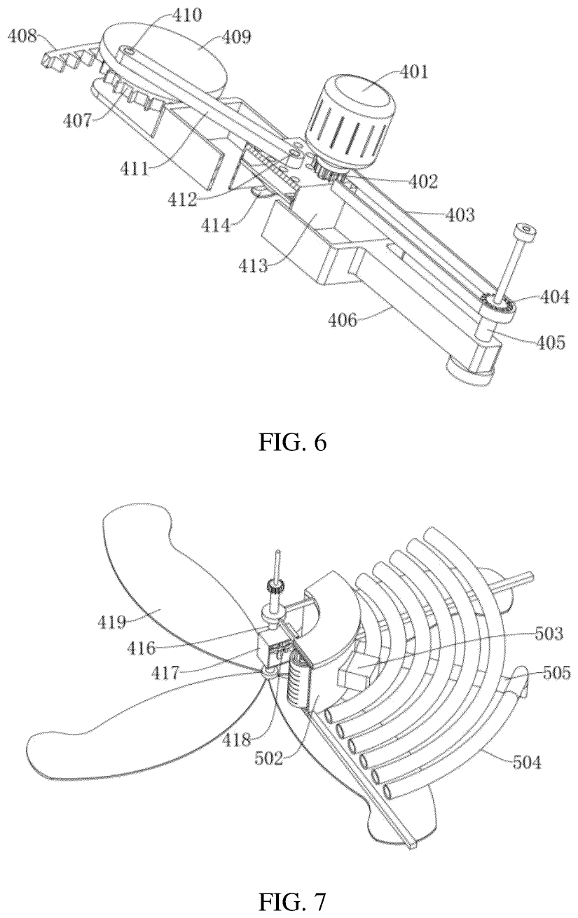

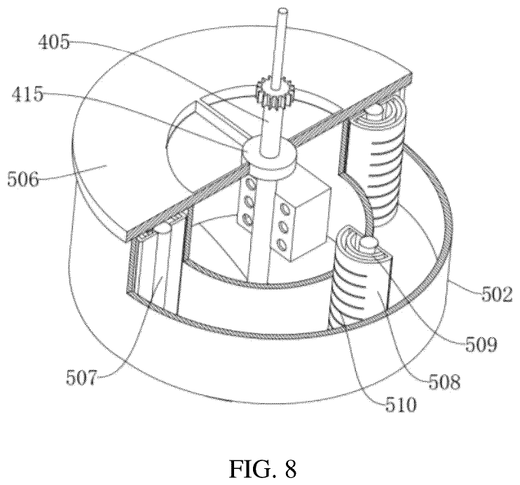

The present application will be described in detail referring to FIGS. 1 through 8 as follows.

An embodiment of the present application discloses a speed reduction rotation device based on photovoltaic modules.

### Embodiment 1

Referring to FIGS. 1, 2, and 3, a Speed Reduction rotation device based on photovoltaic modules includes a high tooth-slot torque permanent magnet motor 1 and a planetary reducer 2. The output end of the high tooth-slot torque permanent magnet motor 1 is connected to the input end of the planetary reducer 2. When in use, the output end of the planetary reducer 2 is connected to the actuator shaft of the photovoltaic module. After the high tooth-slot torque permanent magnet motor 1 outputs torque, the planetary reducer 2 amplifies the torque according to the speed ratio and supplies it to the actuator shaft, thereby achieving the purpose of driving the photovoltaic module to rotate. In this application, the high tooth-slot torque permanent magnet motor 1 is a high tooth-slot torque permanent magnet brushless DC motor, which features stable torque, low starting current, high efficiency, and fast response, making it suitable for rotational adjustment of photovoltaic modules.

Specifically, to facilitate the installation of the high tooth-slot torque permanent magnet motor 1, a mounting base 3 is fixed at the bottom of the high tooth-slot torque permanent magnet motor 1, and at least two waist-shaped mounting holes 31 are provided on the mounting base 3.

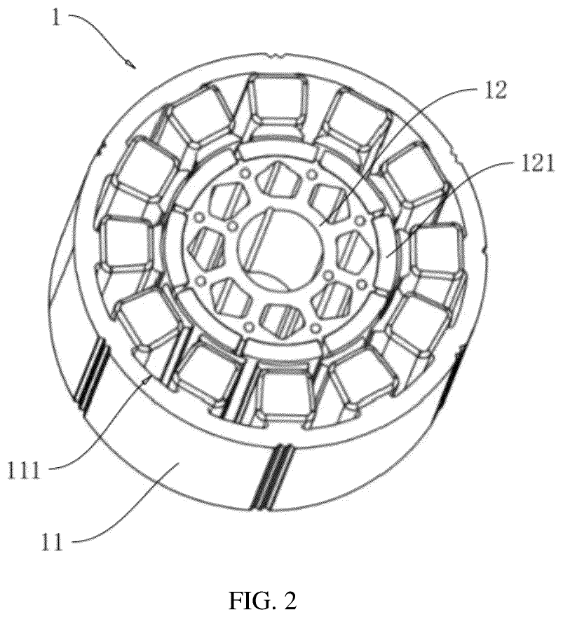

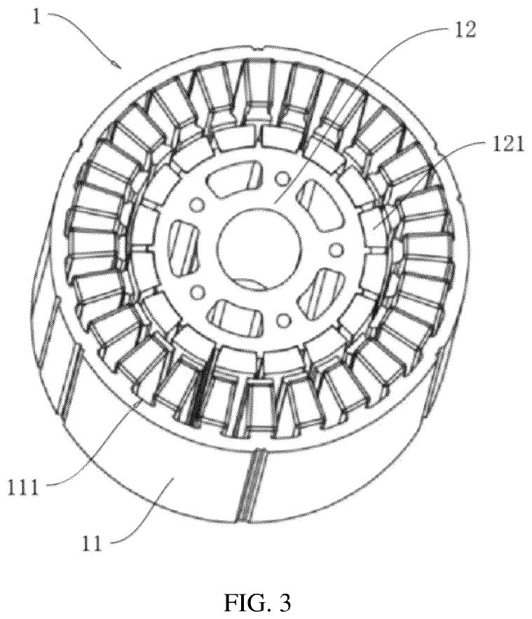

Referring to FIGS. 2 and 3, the high tooth-slot torque permanent magnet motor 1 includes a stator body 11 and a rotor body 12 arranged inside the stator body 11. The inner peripheral surface of the stator body 11 is provided with M stator slots 111, and N permanent magnets 121 are arranged around the outer periphery of the rotor body 12, with M:N being a multiple of 3:2. The N permanent magnets 121 are affixed in a circular array to the outer side wall of the rotor body 12. Thus, the high tooth-slot torque permanent magnet motor 1 has an internal rotor structure, resulting in small rotor inertia, fast response speed, and high protection level. The permanent magnets 121 have a surface-mounted structure, enabling the high tooth-slot torque permanent magnet motor 1 to have high power density and magnetic field utilization, ensuring high efficiency and high control precision. In this embodiment, M:N is 12:8 or 24:16, meaning that in this embodiment, the slot-to-pole ratio of the high tooth-slot torque permanent magnet motor 1 is 12:8 or 24:16.

Specifically, in the present application, the slot-to-pole ratio of the high tooth-slot torque permanent magnet motor 1 is a multiple of 3:2. Through the slot-pole coordinated motor structure, the purpose of increasing the tooth-slot torque is achieved. Compared to the self-locking feature of a worm gear reducer, the present application utilizes the high tooth-slot torque of the high tooth-slot torque permanent magnet motor 1. After amplifying the torque through the speed ratio of the planetary reducer 2, it similarly achieves sufficient reverse braking torque, capable of resisting reverse torque on the actuator shaft caused by external forces such as strong winds or foreign objects. Additionally, using the planetary reducer 2 instead of the worm gear reducer to achieve speed reduction and rotation of the actuator shaft is beneficial for improving service life, energy efficiency, and reliability, while reducing product costs.

Referring to FIGS. 1, 2, and 3, to ensure that the high tooth-slot torque permanent magnet motor 1 has high efficiency and power density, thereby reducing energy consumption, improving energy efficiency, and achieving motor lightweighting, the pole arc coefficient of the high tooth-slot torque permanent magnet motor 1 is greater than 0.75. To ensure that the planetary reducer 2 has a large speed reduction ratio, making the speed reduction rotation mechanism suitable for low-speed and high-torque transmission applications, the speed reduction ratio of the planetary reducer 2 is greater than 10,000:1.

The operating principle of the speed reduction rotation device based on photovoltaic modules according to an embodiment of the present application is as follows: During use, the output end of the planetary reducer 2 is connected to the actuator shaft of the photovoltaic module. After the high tooth-slot torque permanent magnet motor 1 outputs torque, the planetary reducer 2 with a large speed ratio amplifies the torque according to the speed ratio and supplies it to the actuator shaft, thereby achieving the purpose of driving the photovoltaic module to rotate.

Specifically, in the present application, the slot-to-pole ratio of the high tooth-slot torque permanent magnet motor 1 is a multiple of 3:2. Through the coordinated slot-pole motor structure, the purpose of increasing the tooth-slot torque is achieved. Compared to the self-locking feature of a worm gear reducer, the present application utilizes the high tooth-slot torque of the high tooth-slot torque permanent magnet motor 1. After amplifying the torque through the speed ratio of the planetary reducer 2, it similarly achieves sufficient reverse braking torque, capable of resisting reverse torque on the actuator shaft caused by external forces such as strong winds or foreign objects. Additionally, using the planetary reducer 2 instead of the worm gear reducer to achieve speed reduction and rotation of the actuator shaft is beneficial for improving service life, energy efficiency, and reliability, while reducing product costs.

Embodiment 2, Referring to FIGS. 1, 2, and 3, a speed reduction rotation device based on photovoltaic modules includes a high tooth-slot torque permanent magnet motor 1 and a planetary reducer 2. The output end of the high tooth-slot torque permanent magnet motor 1 is connected to the input end of the planetary reducer 2. When in use, the output end of the planetary reducer 2 is connected to the actuator shaft of the photovoltaic module. After the high tooth-slot torque permanent magnet motor 1 outputs torque, the planetary reducer 2 amplifies the torque according to the speed ratio and supplies it to the actuator shaft, thereby achieving the purpose of driving the photovoltaic module to rotate.

Referring to FIGS. 1, 4, 5, 6, 7, and 8, in a preferred embodiment, the planetary reducer 2 is internally provided with a cooling assembly 4. The cooling assembly 4 includes a drive motor 401, which is fixedly connected to the inner wall of the top surface of the planetary reducer 2, and the power output shaft of the drive motor 401 is connected via a coupling to a first gear 402. The surface of the first gear 402 engages with a synchronous belt 403, and the inner wall of the end of the synchronous belt 403 away from the first gear 402 engages with a second gear 404. The top surface of the second gear 404 is fixedly connected to a first shaft rod, which is rotatably arranged within a first shaft seat fixedly connected to the central inner wall of the top surface of the planetary reducer 2. The bottom surface of the second gear 404 is fixedly connected to a fixed rod 405, whose surface is fixedly connected to a rotating bracket 406. The rotating bracket 406 is rotatably arranged above the end of the fixed rod 405 away from it and is fixedly connected to a third gear 407 at its top surface. The bottom surface of the third gear 407 is fixedly connected to a second shaft rod, which is rotatably arranged within a second shaft seat fixedly connected to the top surface of the rotating bracket 406. The inner wall of the planetary reducer 2 is fixedly connected to an annular rack 408, which engages with the third gear 407. The top surface of the third gear 407 is fixedly connected to a rotating disk 409. One end of the top surface of the rotating disk 409 is fixedly connected to a first eccentric rod 410, whose surface is rotatably provided with a rotating plate 411. The interior of the rotating bracket 406 is provided with a moving channel, within which a first fan bracket 413 is slidably arranged. The inner wall of the first fan bracket 413 is fixedly equipped with a first fan 414, and the central top surface of the first fan bracket 413 is fixedly connected to a rotating rod 412. The rotating plate 411 is rotatably arranged on the surface of the rotating rod 412 away from the third gear 407. The bottom surface of the fixed rod 405 is fixedly connected to a fixed disk 415, whose bottom surface is fixedly connected to a transmission rod 416. The outer wall of the transmission rod 416 is fixedly connected to a second fan bracket 417, whose inner wall is fixedly equipped with a second fan 418. The bottom surface of the transmission rod 416 is fixedly connected to a fan blade 419.

Specifically, during the operation of the planetary reducer 2, the drive motor 401 is started to rotate the first gear 402. Both the first gear 402 and the second gear 404 engage with the synchronous belt 403, causing the second gear 404 to drive the fixed rod 405 and the rotating bracket 406 to rotate. This causes the first fan 414 to rotate within the planetary reducer 2, achieving uniform cooling at different positions inside the planetary reducer 2. When the rotating bracket 406 rotates, the third gear 407 engages with the annular rack 408, causing the rotating disk 409 to rotate. The rotating disk 409 drives the first eccentric rod 410 to rotate, which in turn rotates the rotating plate 411. Simultaneously, the first fan bracket 413 slides within the rotating bracket 406, and the first fan 414 moves horizontally to cool different positions within the planetary reducer 2, thereby achieving uniform cooling within the planetary reducer 2 with good cooling effects, avoiding localized overheating, and ensuring the quality and lifespan of the planetary reducer 2. When the fixed rod 405 rotates, the fan blade 419 rotates accordingly, in conjunction with the first fan 414, directing heat away and accelerating the cooling process.

Referring to FIGS. 1, 4, 5, 7, and 8, in a preferred embodiment, the planetary reducer 2 is internally provided with a cooling component 5. The cooling component 5 includes a fixed bracket 501, which is fixedly connected to the inner wall of the planetary reducer 2. One end of the fixed bracket 501 away from the planetary reducer 2 is fixedly connected to a cooling water tank 502. The cooling water tank 502 is centrally hollow. The second fan bracket 417 and the second fan 418 are arranged within the central hollow portion of the cooling water tank 502. The fan blade 419 is rotatably arranged below the cooling water tank 502. The outer wall of the cooling water tank 502 is fixedly connected to a circulation pump 503. The input end of the circulation pump 503 is fixedly connected to the outlet of the cooling water tank 502 via a pipe, and the output end of the circulation pump 503 is fixedly connected to a cooling coil 504. The cooling coil 504 is fixedly connected to a return pipe 505 at the end away from the circulation pump 503, and the return pipe 505 is fixedly connected to the return inlet of the cooling water tank 502 at the end away from the cooling coil 504. The cooling coil 504 is arranged between the first fan 414 and the fan blade 419. The outer wall of the fixed disk 415 is fixedly connected to a rotating cover 506. The rotating cover 506 is rotatably arranged on the top surface of the cooling water tank 502, and the outer end of the bottom surface of the rotating cover 506 is fixedly connected to multiple second eccentric rods 507 arranged in a circular array. The second eccentric rod 507 is rotatably arranged inside the cooling water tank 502. The outer wall of the second eccentric rod 507 is fixedly connected to a first turbulence plate 508, and the inner wall of the first turbulence plate 508 is fixedly connected to a second turbulence plate 509. Multiple turbulence grooves 510 are arranged within the first turbulence plate 508 and the second turbulence plate 509.

Specifically, during the cooling process, the first fan 414 generates wind force that acts on the cooling coil 504. The airflow is cooled through the cooling coil 504, thereby reducing its temperature. The cooled airflow then acts on the interior of the planetary reducer 2, enhancing the cooling effect. The circulation pump 503 extracts the cooling liquid from the cooling water tank 502, allowing the cooling liquid to flow through the interior of the cooling coil 504 and return to the cooling water tank 502 via the return pipe 505, thereby achieving cooling liquid circulation. When the fixed rod 405 rotates, the fixed disk 415 rotates accordingly, causing the rotating cover 506 to rotate along the top surface of the cooling water tank 502. The second eccentric rod 507 moves within the cooling water tank 502, driving the first turbulence plate 508 and the second turbulence plate 509 to move within the cooling water tank 502. The first turbulence plate 508 and the second turbulence plate 509 create turbulence in the cooling liquid within the cooling water tank 502 through their turbulence grooves 510, enhancing the flow of the cooling liquid and accelerating the cooling speed. Simultaneously, the fixed disk 415 drives the transmission rod 416 to rotate, and the second fan bracket 417, equipped with the second fan 418, blows air towards the inner wall of the cooling water tank 502. This further reduces the temperature of the cooling water tank 502 and improves the cooling effect, thereby ensuring the quality and lifespan of the planetary reducer 2.

Specifically, in the operating principle of the speed reduction rotation device based on photovoltaic modules according to an embodiment of the present application: During the use of the planetary reducer 2, the drive motor 401 is started to rotate the first gear 402. Both the first gear 402 and the second gear 404 engage with the synchronous belt 403, causing the second gear 404 to drive the fixed rod 405 and the rotating bracket 406 to rotate. This rotation causes the first fan 414 to rotate within the planetary reducer 2, achieving uniform cooling at different positions inside the planetary reducer 2. When the rotating bracket 406 rotates, the third gear 407 engages with the annular rack 408, causing the rotating disk 409 to rotate. The rotating disk 409 drives the first eccentric rod 410 to rotate, which in turn rotates the rotating plate 411. Simultaneously, the first fan bracket 413 slides within the rotating bracket 406, and the first fan 414 moves horizontally to cool different positions within the planetary reducer 2, thereby achieving uniform cooling within the planetary reducer 2 with good cooling effects, avoiding localized overheating, and ensuring the quality and lifespan of the planetary reducer 2. When the fixed rod 405 rotates, the fan blade 419 rotates accordingly, in conjunction with the first fan 414, directing heat away and accelerating the cooling process. During the cooling process, the wind force generated by the first fan 414 acts on the cooling coil 504. The airflow is cooled through the cooling coil 504, reducing its temperature. The cooled airflow then acts on the interior of the planetary reducer 2, enhancing the cooling effect. The circulation pump 503 extracts the cooling liquid from the cooling water tank 502, allowing the cooling liquid to flow through the interior of the cooling coil 504 and return to the cooling water tank 502 via the return pipe 505, thereby achieving cooling liquid circulation. When the fixed rod 405 rotates, the fixed disk 415 rotates accordingly, causing the rotating cover 506 to rotate along the top surface of the cooling water tank 502. The second eccentric rod 507 moves within the cooling water tank 502, driving the first turbulence plate 508 and the second turbulence plate 509 to move within the cooling water tank 502. The first turbulence plate 508 and the second turbulence plate 509 create turbulence in the cooling liquid within the cooling water tank 502 through their turbulence grooves 510, enhancing the flow of the cooling liquid and accelerating the cooling speed. Simultaneously, the fixed disk 415 drives the transmission rod 416 to rotate, and the second fan bracket 417, equipped with the second fan 418, blows air towards the inner wall of the cooling water tank 502, further reducing the temperature of the cooling water tank 502 and improving the cooling effect, thereby ensuring the quality and lifespan of the planetary reducer 2.

The above are preferred embodiments of the present application and do not limit the scope of protection sought by the present application. Therefore, any equivalent changes made to the structure, shape, or principle of the present application are intended to be covered by the scope of protection of the present application.

What is claimed is:

1. A speed reduction rotation device based on photovoltaic modules, comprising:
a high tooth-slot torque permanent magnet motor comprising an output end;
a planetary reducer, connected to the output end of the high tooth-slot torque permanent magnet motor;
wherein the high tooth-slot torque permanent magnet motor comprises a stator body and a rotor body, the stator body is provided with a plurality of stator slots, the rotor body is provided with a plurality of permanent magnets, and the ratio of the number of stator slots to permanent magnets is a multiple of 3:2.

2. The speed reduction rotation device based on photovoltaic modules according to claim 1, wherein the pole arc coefficient of the high tooth-slot torque permanent magnet motor is greater than 0.75.

3. The speed reduction rotation device based on photovoltaic modules according to claim 2, wherein the stator slots are affixed to an outer peripheral surface of the rotor body.

4. The speed reduction rotation device based on photovoltaic modules according to claim 2, wherein the rotor body is arranged inside the stator body.

5. The speed reduction rotation device based on photovoltaic modules according to claim 1, wherein the speed reduction ratio of the planetary reducer is greater than 10,000:1.

6. The speed reduction rotation device based on photovoltaic modules according to claim 1, wherein the high tooth-slot torque permanent magnet motor comprises a mounting base at its bottom, and the mounting base is provided with at least two waist-shaped mounting holes.

7. The speed reduction rotation device based on photovoltaic modules according to claim 1, wherein the high tooth slot torque permanent magnet motor is a high tooth slot torque permanent magnet brushless DC motor.

8. The speed reduction rotation device based on photovoltaic modules according to claim 1, wherein the planetary reducer comprises: a cooling assembly which comprises a drive motor fixedly connected to an inner wall of a top surface of the planetary reducer; a first gear connected to a power output shaft of the drive motor via a coupling; a synchronous belt engaged with the first gear; a second gear engaged with the synchronous belt at an end away from the first gear; and a first shaft rod fixedly connected to a top surface of the second gear and rotatably arranged within a first shaft seat fixedly connected to the central inner wall of the planetary reducer.

9. The speed reduction rotation device based on photovoltaic modules according to claim 8, wherein a fixed rod is connected to a bottom surface of the second gear; a rotating bracket is fixedly connected to a surface of the fixed rod; a third gear rotatably is disposed above an end of the rotating bracket that is away from the fixed rod; a second shaft rod is fixedly connected to a bottom surface of the third gear; a second shaft seat is fixed connected to a top surface of the rotating bracket, and the second shaft rod is rotatably arranged in the second shaft seat; and an annual rack fixedly connected to the inner wall of the planetary reducer, the third gear is engaged with the annual rack.

10. The speed reduction rotation device based on photovoltaic modules according to claim 9, wherein a top surface of the third gear is fixedly connected to a rotating disk, the rotating disk is fixedly connected to a first eccentric rod at one end of its top surface, the first eccentric rod is provided with a rotating plate on its surface, the rotating bracket is provided with a moving channel within which a first fan bracket is slidably arranged, the first fan bracket is fixedly equipped with a first fan on its inner wall, a central top surface of the first fan bracket is fixedly connected to a rotating rod, and the rotating plate is rotatably arranged on a surface of the rotating rod away from the third gear.

11. The speed reduction rotation device based on photovoltaic modules according to claim 10, wherein a bottom surface of the fixed rod is fixedly connected to a fixed disk, the fixed disk is fixedly connected to a transmission rod, an outer wall of the transmission rod is fixedly connected to a second fan bracket, the second fan bracket is fixedly equipped with a second fan on its inner wall, and a bottom surface of the transmission rod is fixedly connected to a fan blade.

12. The speed reduction rotation device based on photovoltaic modules according to claim 11, wherein the planetary reducer is internally provided with a cooling component, the cooling component comprising:
a fixed bracket fixedly connected to the inner wall of the planetary reducer;
a cooling water tank fixedly connected to an end of the fixed bracket away from the planetary reducer, the cooling water tank being centrally hollow;
a second fan bracket and a second fan arranged within the central hollow portion of the cooling water tank;
a fan blade rotatably arranged below the cooling water tank;
a circulation pump fixedly connected to an outer wall of the cooling water tank, an input end of the circulation pump fixedly connected to an outlet of the cooling water tank via a pipe; and
a cooling coil fixedly connected to an output end of the circulation pump, the cooling coil fixedly connected to a return pipe at an end away from the circulation pump, and the return pipe fixedly connected to a return inlet of the cooling water tank at an end away from the cooling coil, the cooling coil being arranged between the first fan and the fan blade.

13. The speed reduction rotation device based on photovoltaic modules according to claim 12, wherein:
an outer wall of the fixed disk is fixedly connected to a rotating cover;
the rotating cover is rotatably arranged on a top surface of the cooling water tank;
an outer end of the bottom surface of the rotating cover is fixedly connected to multiple second eccentric rods arranged in a circular array;
the second eccentric rods are rotatably arranged inside the cooling water tank;
an outer wall of each second eccentric rod is fixedly connected to a first turbulence plate;
an inner wall of each first turbulence plate is fixedly connected to a second turbulence plate;
multiple turbulence grooves are arranged within each first turbulence plate and each second turbulence plate.
